(19) United States
(12) Patent Application Publication
(10) Pub. No.: US 2006/0272777 A1
(43) Pub. Date: Dec. 7, 2006

(54) Device, machine and method for applying glue capable of flowing

(76) Inventors: Andreas Buda, Zurich (CH); Hanspeter Felix, Strengelbach (CH)

Correspondence Address: MOETTELI & ASSOCIATES SARL, ST. LEONHARDSTRASSE 4, ST. GALLEN, CH-9000, CH

(21) Appl. No.: 11/421,822

(22) Filed: Jun. 2, 2006

(30) Foreign Application Priority Data
Jun. 3, 2005 (EP) 05011979.1

(51) Int. Cl. B32B 37/02; B05C 5/02

(52) U.S. Cl. 156/356

(57) ABSTRACT

A machine and method is provided for applying a fluent adhesive or glue to a surface in two or more parallel strips at a adjustable distance apart. The machine has a plurality of glue nozzles mounted on a radius of a suspension device, which has an arcuate shape and is pivotable about the axis of the radius of the arc. The parallel adhesive strips are accomplished by applying the glue to the surface while moving the surface linearly past the nozzles. Adjustment of the distance apart is accomplished by rotation of the arc of the suspension device about its pivot axis by a swivelling means, which alters the angular distance between the nozzles relative to the direction of movement.

The present application claims the benefit of prior filed European Patent Organization Application, serial number EP 05 011979.1 filed 3 Jun. 2005, to which the present application is a regular U.S. national application. FIELD OF THE INVENTION

The present invention is in the field of machines, devices and methods for the application of adhesives in at least two parallel tracks.

### BACKGROUND OF THE INVENTION

When processing printed products, but also in other fields, there is a need to apply two or more parallel glue breads, in order to be able to glue on for example a book cover or the like.

Within the printing field one talks about so-called side coating, which consist typically of two glue beads running parallel to each other on each side of an already bound book block. These glue beads run along the bound back on the front and back side of the book block. After application of the side glue the back of the book, or another cover is then put and pressed around the back of the book provided with side glue.

One of the problems in the field lies in the fact that a machine for applying the side glue should be applicable as flexibly as possible, so that it can be adapted fast and problem-free with respective to a specific printing order. This presupposes that on the one hand the distance between the glue beads must be adjustable and that on the other hand such a machine should be adaptable also to the thickness of the respective book which is to be glued.

In the past side glueing machines drums are used, which are guided through a glue basin, in order to then apply the necessary glue coating on the book block. This approach is particularly complex with PUR-based adhesives, since PUR hardens relatively quickly if exposed to air. In addition, the re-configuring of such a machine can be relatively complex. The conventionally working machines are also problematic if glue beads with a distance of less than 10 mm have to be applied.

Therefore it is an object to provide a glue application device and a machine based on such a device which allows easy and flexible application of at least two glue beads running parallel to each other. In addition, a corresponding method is to be provided.

It is regarded to be particularly important that a precise adjustability of the distance between glue strips of less than 10 mm is possible. In addition the application of the glue must be homogeneous and reproducible. It is also important that the devices and machines are suited for processing PUR-based glue or Hotmelt.

### SUMMARY OF THE INVENTION

The present invention includes a glue applying device, a machine incorporating the glue application device, and a method for using the device and machine in combination to reproducibly apply at least two glue beads running parallel to each other. In addition, a corresponding method is to be provided. It is a particularly important feature of the invention that it is possible to precisely adjust the distance between glue strips to distance of less than 10 mm.

The glue application device is capable of applying glue capable of flowing in two strips summing essentially parallel on surface. The glue device comprises at least two nozzles, mechanically fastened to a suspension member. The nozzles are mechanically fastened and arranged with respect to each other at a given distance apart. The suspension member has an arc-shaped toothed segment disposed to mate with a pinion gear. The pinion meshes with the toothed segment, and rotation of the pinion around a pinion axis is converted into a rotation of the toothed segment around a suspension axis, whereby the suspension member is swivelled around the suspension axis by of rotation of the pinion. By swivelling the suspension member, the distance between the parallel running strips is adjustable.

In a preferred embodiment, the pinion gear is controlled and driven by a manual means, (e.g., a crank handle), or by an engine or motor. In this embodiment, the glue applying device is mounted in combination with a machine of which the pinion gear and drive means comprise a part. It is a feature of the present embodiment that a continuous (or step-less) drive means, like the pinion and toothed gear mechanism, provide very precise adjustability of the distance between adjacent glue line of between 0 and 10 mm. The invention is particularly suitable for the application of glue with variable strip distance. The distance can be adjusted very easily and exactly. Further advantages of the invention can be derived from the figures and the following description.

### BRIEF DESCRIPTION OF THE DRAWINGS

FIG. 1 is a perspective view of a preferred embodiment of a glue application device of the present invention.

FIG. 2 is a side view of the preferred embodiment of a glue application device of FIG. 1.

FIG. 3A is a schematic sectional view of a book block with cover.

FIG. 3B is a cutout enlargement of the FIG. 3A.

FIG. 4A is partial side view of a further glue application device of the invention showing application of a single glue line to a surface.

FIG. 4B is partial side view of the glue application device of FIG. 4A showing how swivelling of the device relative to FIG. 4A provides for controlled adjustment of the distance between two parallel glue lines.

FIG. 5 is a further partial side view of a glue application device of the present invention.

FIG. 6 is a schematic side view of two glue application devices disposed to apply glue lines to two sides of a book block.

FIG. 7 is perspective view of a preferred embodiment of the present invention in which two glue application devices are combined in a glueing machine.

### DETAILED DESCRIPTION OF THE INVENTION

Referring now to the drawings, the details of preferred embodiments of the present invention are graphically and schematically illustrated. Like elements in the drawings are represented by the like numbers, and any similar elements are represented by like numbers with a different lower case letter suffix.

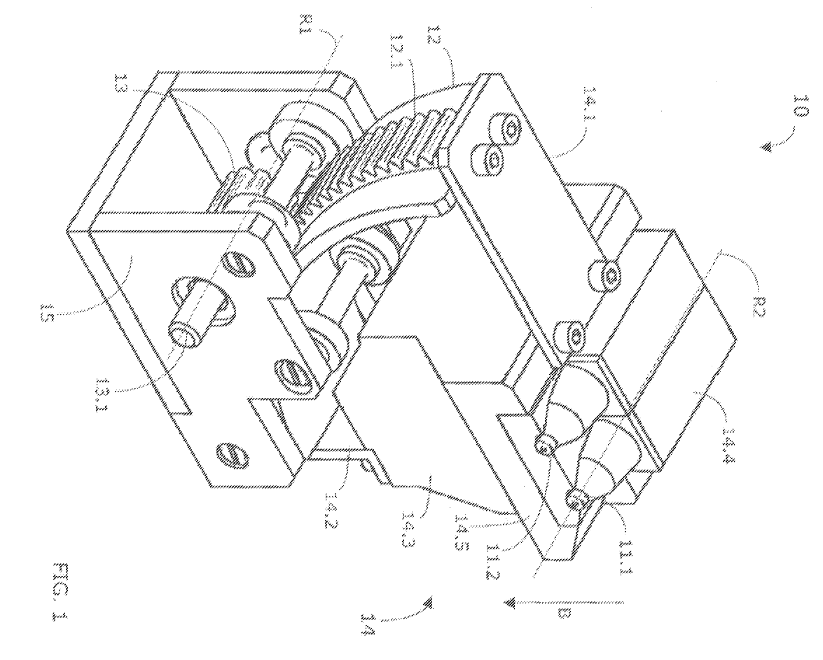

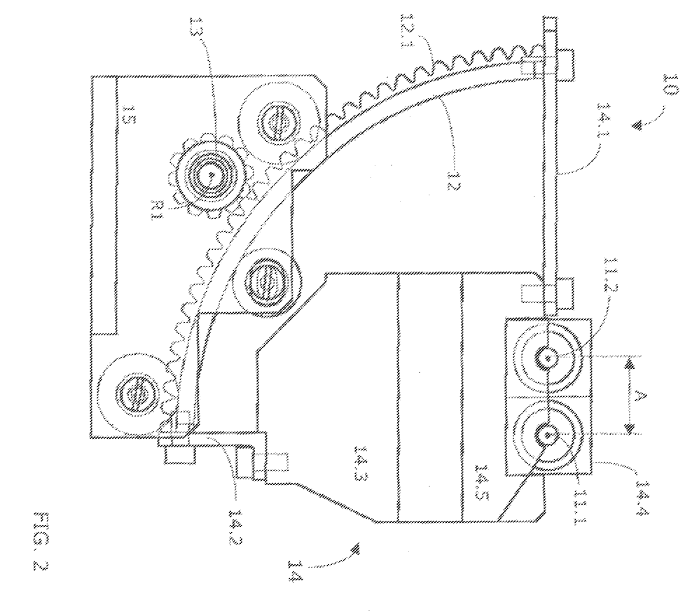

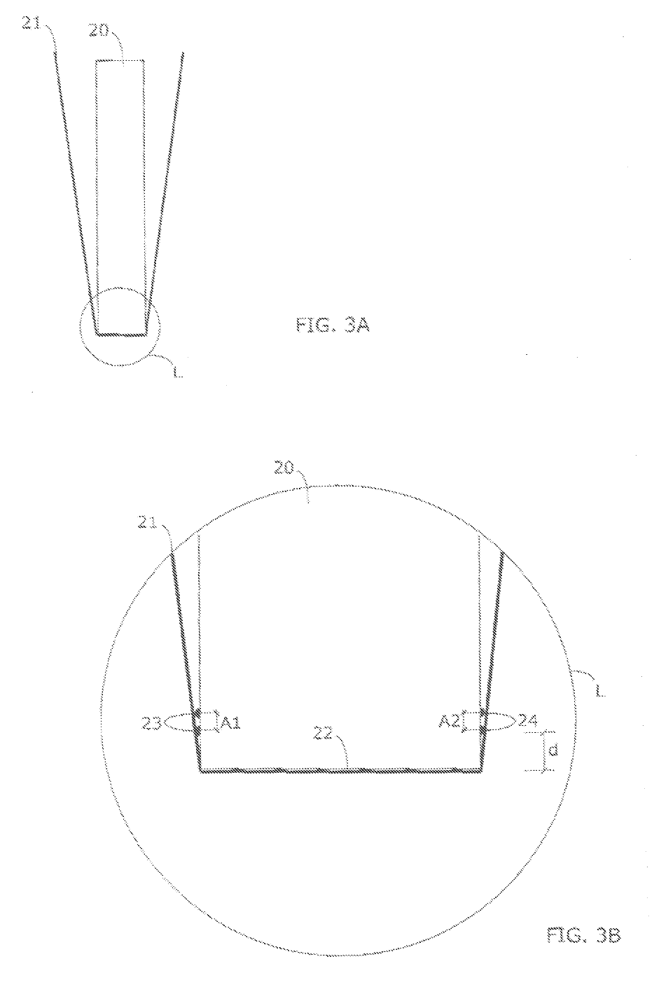

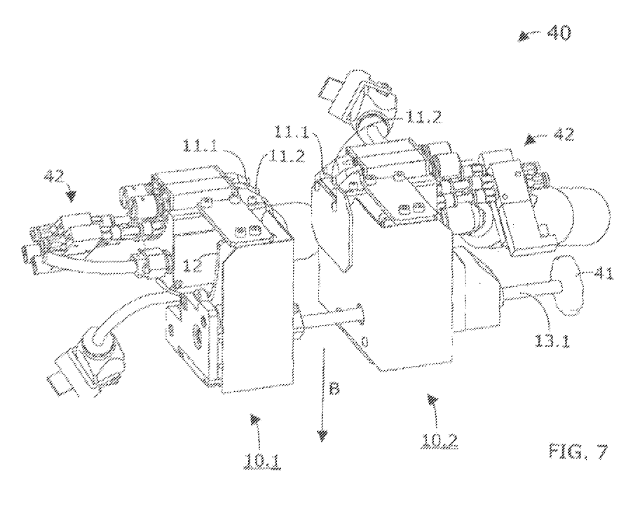

The present invention concerns a machine comprising at least one glue application device for use in the application on a surface of two or more glue paths running parallel to each other. These paths are also called glue beads. In FIGS. 1 and 2, a preferred glue application device 10 according to invention is shown. The glue application device 10 is part of a machine 40 (see FIG. 7). The glue device 10 serves in the example shown for applying fluid glue in two essentially parallel running strips 23 or 24 on an object or surface 20, see FIGS. 3A and 3B. In accordance with invention the device 10 comprises two nozzles 11.1, 11.2 and a suspension member 14 to which the two nozzles 11.1 & 11.2 are mechanically fastened and arranged with respect to each other, so that their mutual distance A is given, as shown in FIG. 2. Although only a pair of glue nozzles 11.1 & 11.2 are shown in the figure, one of ordinary skill in the art knows that more than two such nozzles are intended and can be practiced in the present invention. The suspension 14 may comprise several elements 14.1˜14.5. Further a mounting block 15 or the like is provided.

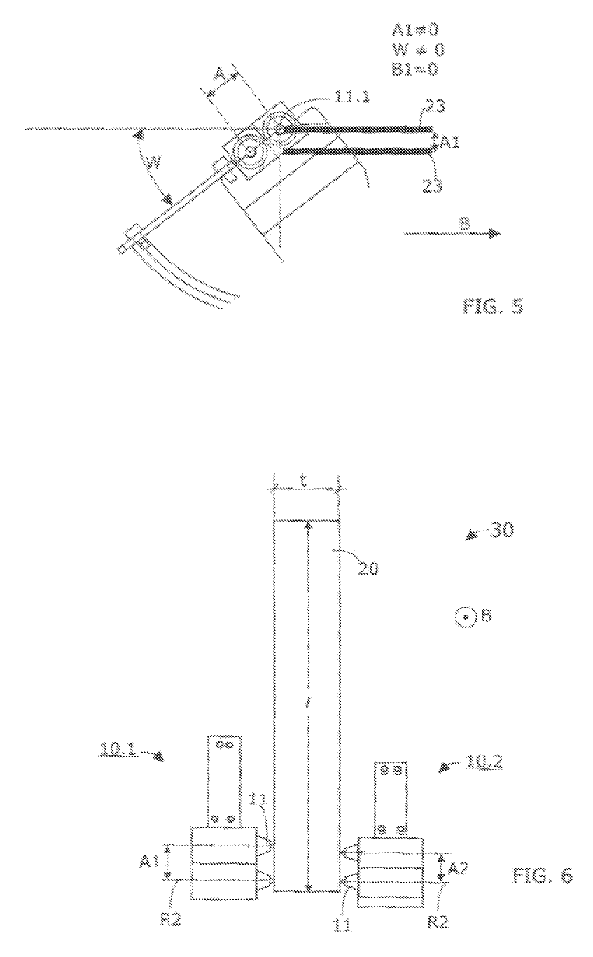

The suspension member 14 has an arc-shaped toothed segment 12 connected to it. In the embodiment illustrated, the arc-shaped toothed segment 12 comprises teeth 12.1 external to the arc-shape. A pinion gear 13 meshes with the toothed segment 12. The toothed segment 12 and the pinion 13 are arranged with respect to each other and dimensioned so that rotation of the pinion 13 around a pinion axis R1 is converted into a rotation of the toothed segment 12 around a rotation axis R2. Thereby also the suspension member 14 moves around the axis of rotation R2. In the preferred embodiment illustrated, the axis of rotation R2 runs through the first glue nozzle 11.1 (see for example FIG. 6), which configuration provides that the distance d between the back 22 of the book and the first nozzle 11.1 always remains constant.

In FIGS. 3A and 3B further details of the principle according to the invention are recognizable. FIG. 3A shows a side view of a book block 20 with a cover (book cover 21). The insert marked with an L is shown with magnification in FIG. 3B. FIG. 3B shows a condition of the book block 20 after applying two pairs of parallel glue beads 23 & 24 running on both sides of the book block 20. The distance A1 between glue beads 23 on one side of the book block 20 and the distance A2 between the glue beads 24 on the other side of the block 20 can be unequal. The distance d from the first glue bead 23 & 24 on a side to the back of the book 22 is typically is constant. However, the distance d between the back 22 of the book block 20 and the first glue strip 23 & 24 can be separately adjusted on each side.

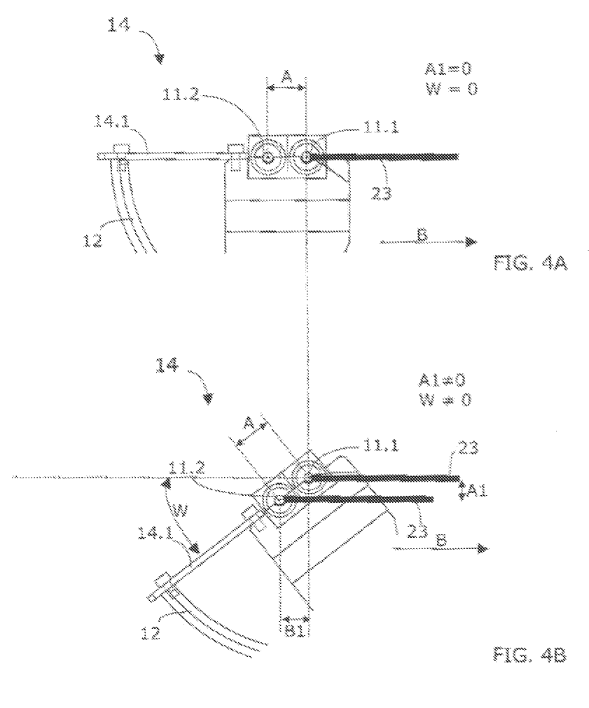

By swivelling the suspension member 14, the distance A1 and/or A2 between the parallel running bead strips 23 & 24 can be adjusted, as described in FIGS. 4A and 4B. In a preferred embodiment, with the glue nozzles in a zero-position (angle W=zero), application of glue to the surface can be controlled so that both nozzles 11.1 & 11.2 deliver glue alternating. Thus both nozzles are loaded more evenly. With the suspension member 14 in the zero-position (W=0), only a single glue strip 23 is applied, since both nozzles if viewed in the direction of motion B lie one behind the other.

In FIGS. 4A and 4B, a part of the elements 14.1, 14.3, 14.4 & 14.5 of the device 10 called suspension member 14 is shown. In addition, the two nozzles 11.1 & 11.2 are visible. In FIG. 4A, a configuration is shown where the suspension member 14 has not been swivelled, and where thus both glue nozzles 11.1 & 11.2 are in line with each other relative to the direction of motion B (i.e., W=0). If in FIG. 4A, glue is dispensed from one or both of the two nozzles 11.1 & 11.2, only one glue beads 23 results. The direction of motion B of the object or surface relative to the glue nozzles 11.1 & 11.2 is shown in FIGS. 4A and 4B. The glue beads 23 extend parallel to the direction of motion B.

If now the suspension member 14, including the glue nozzles 11.1 & 11.2, is turned in a counter-clockwise direction (angle W≠0), the configuration shown in FIG. 4B results. Now if at the same time glue is dispensed from both nozzles 11.1 & 11.2, two glue beads 23 running in parallel to each other are applied to the object. The glue beads 23 extend parallel to the direction of motion B. Since the two glue nozzles 11.1 & 11.2 are offset in parallel to the direction of motion B, glue beads 23 running in parallel to each other result, which begin with an offset distance B1, as indicated in FIG. 4B. The distance between the two glue beads 23 is denoted with A1. In a particularly preferred embodiment, the offset distance B1 is equalized, by the glue dispensing from the two nozzles 11.1 & 11.2 being controlled in such a way that the nozzle 11.1 begins to deliver glue somewhat later than the nozzle 11.2. That is, the spatial offset distance B1 is preferable eliminated by an appropriate temporal offset (so that B1=0 or is reduced). This feature is indicated in FIG. 5.

In the FIG. 6 parts of a machine 30 according to the invention are shown. The machine 30 comprises in the example shown two devices 10.1 & 10.2, which can be implemented similarly or equal as in the FIGS. 1 and 2. FIG. 6 is a schematized illustration in which one can recognize the two devices 10.1 & 10.2 and the object 20 (a book block without book cover or binding). The relative movement of the object 20 in relation to the devices 10.1 & 10.2 runs perpendicularly to the paper plane and is indicated by B. The device 10.1 has not been swivelled by the rotation of the mentioned pinion. Therefore, the strip distance A1 corresponds to the distance A of the two nozzles. The distance A1 is maximum since R2 runs through one of the nozzles 11.1. The device 10.2 however, was swivelled by the rotation of the mentioned pinion 13 and the strip distance A2 thus is smaller than the distance A between the two nozzles 11.1 & 11.2.
(A=A1>A2).
Preferable by a proper gear combination of pinion 13 and toothed segment 12, a reduction in the degree of rotation is obtained. In a particularly preferred embodiment, the gear ratio of the pinion 13 to the tooth dear 12.1 is about established so that upon revolution of the shaft 13.1 a linear enlargement or reduction of the strip distance A1 or A2 is obtained. Preferably by the combination of pinion 13 and toothed gear 12.1 a reduction into the slow is obtained. “A reduction into the slow” is a technical phrase used in gear technology to describe that a faster motion is translated into a slower motion. For example, if one turns the pinion gear 13 360 degrees, the toothed segment 12.1 will only turn a small fraction of the 360 degrees. In FIG. 6, only a part 14.1 & 14.4 of the suspension member 14 is visible. The toothed segment, the pinion and the further elements are not shown. Moreover, this design is not drawn to scale.

FIG. 7 shows further details of an alterative machine 40. The object 20 is not shown, since it would otherwise cover a part of the elements. Two glue application devices 10.1 & 10.2 are both shown in a perspective representation. An end-to-end shaft 13.1 is provided, which can be turned by the manual rotation of a knob 41. The rotation of the shaft 13.1 is transmitted via a first pinion (not shown) to a toothed segment 12 of the device 10.1 and via a second pinion (not shown) to a toothed segment 12 of the device 10.2. By the rotation of the knob 41 attached to the pinion shaft 13.1, the suspensions members 14 of both glue application devices 10.1 & 10.2 can be swivelled. Due to this, as already described, the strip distance A1 can be adjusted steplessly. Alternatively, the machine 30 or 40 comprises a pinion shaft 13.1, which is driven by a motor (not shown).

Beside some elements, which are not essential for the invention, the glue supply 42 is shown in FIG. 7. As one can recognize, the glue supply has two separate lines, i.e. one line per nozzle 11.1 & 11.2. Control of the machine 40 can be designed so that the glue application initiates at the same time, or, as described on the basis FIG. 5, temporally offset. The temporal offset is preferred, since one can equalize with it the spatial offset B1, which is caused by the rotation. In another embodiment of the machine 40, only one glue supply is intended per device 10.1 & 10.2. In this case, at least one of the nozzles comprises a closing means (e.g., a valve), in order to eliminate the spatial offset B1 or to be able to reduce it. In a further preferred embodiment, the control nozzle control feature is disposed so that application of an intermittent strip is possible. Each individual strip can be configure as dots, dashes or strip-shaped.

In a further preferred embodiment, the machine 30 & 40 is provided with a mechanical and/or electrical display, in order to indicate the size of the strip distance A1 & A2. An embodiment is particularly preferred where there is a feedback between the adjusted strip distance A1 & A2 and the temporal offset. In this case, the control is in the position to determine from the currently adjusted strip distance the necessary temporal offset between the glue dispensing from the first nozzle 11.1 and the glue dispensing from the second nozzle 11.2.

In a further embodiment of the invention, the axis of rotation R2 does not run through any of the glue nozzles 11.1 & 11.2, but runs between the nozzles 11.1 & 11.2. In this case, a symmetrical arrangement is preferred, where the two glue nozzles 11.1 & 11.2 have the same distance to the axis of rotation R2. The suspension member 14 can have two, three or more nozzles 11 arranged parallel to each other. With an odd number of nozzles 11, the axis of rotation R2 can preferably run through the middle nozzle 11. The distance A between adjacent nozzles preferably is 10 mm. This enables a step-less and very precise adjustment between 0 and 10 mm, if the axis of rotation R2 runs through one the two nozzles.

A machine 30 & 40 according to the present invention is useful in connection with the binding of paper (e.g., a book block) or cardboard. The machines 30 & 40 can be designed so that they can process a book block 20 with a thickness t between 1 and 100 mm. The book block length l can be, for example, between 100 mm and 600 mm. Typically, the speed of the translatory relative motion B is between 5 m/min and 200 m/min. The machines 30 & 40 can comprise a heating element, in order to make or keep the glue fluid capable of flowing. Depending upon the embodiment, with the present invention cardboard can be moved with a speed between 100 m/min and 300 m/min, preferably with a speed between 120 m/min and 180 m/min, past the nozzles 11/ It is also preferable that the adhesive in the nozzle 11 is at an idle pressure, in order to be able to immediately deliver glue in the desired quantity after starting the device. By such a measure the device can be stopped at any time, an ready to then start again. With is feature, waste is drastically reduced.

While the above description contains many specifics, these should not be construed as limitations on the scope of the invention, but rather as exemplifications of one or another preferred embodiment thereof. Many other variations are possible, which would be obvious to one skilled in the art. Accordingly, the scope of the invention should be determined by the scope of the appended claims and their equivalents, and not just by the embodiments.

What is claimed is:

1. A device for applying glue capable of flowing in two strips running essentially parallel on an object, wherein the device comprises:
two nozzles;
a suspension member where the two nozzles are mechanically fastened and arranged with respect to each other so that their mutual distance is given; an arc-shaped toothed segment, which is connected with the suspension member; and
a pinion, which meshes with the toothed segment, whereby a rotation of the pinion around a pinion axis is converted into a rotation of the toothed segment around an axis of rotation and whereby by the swivelling of the suspension the distance between the parallel running strips is adjustable.

2. The device according to claim 1, further comprising a control to provide for a glue delivery of the two nozzles in a start-up phase temporally consecutively in order to be able to adjust an offset of the parallel running strips.

3. The device according to claim 1 or 2, characterized in that the arc-shaped toothed segment is a toothed segment with external teeth.

4. The device according to claim 1 or 2, characterized in that the pinion sits on a shaft and can by means of the shaft be manually or by an engine manually be driven.

5. The device according to one of the preceding claims, characterized in that the diameter and the number of teeth of the pinion are selected so that in interaction with the toothed segment a reduction into the slow is obtained.

6. The device according to one of the preceding claims, characterized in that the axis of rotation runs through one of the nozzles and where this nozzle when conducting the swivelling motion does not change its spatial position with respect to the object.

7. The device according to claim 6, characterized in that when conducting the swivelling motion the other nozzle performs a rotating motion around the axis of rotation, whereby the maximum adjustable distance of the parallel running strips is defined by the mutual distance of the two nozzles.

8. The device according to claim 7, characterized in that the distance of the parallel running strips is adjustable between 0 and the maximum adjustable distance by the notation of the pinion.

9. A machine for binding books, characterized in that it comprises at least one device according to one of the claims 1 to 8, whereby the object is a number of sheets or cardboards which are to be bound or to coated.

10. The machine according to claim 9, characterized in that a relative motion between the object and the device is achieved, whereby the direction of motion of the relative motion runs essentially parallel to the two strips.

11. The machine according to claim 9 or 10, characterized in that axis of rotation stands perpendicularly to the direction of motion and preferable cuts through between the two or cuts one of the two strips.

12. The machine according to one of the claims 9 to 11, characterized in that is concerns a PUR-glue or a Hotmelt glue.

13. The machine according to one of the claims 9 to 11, characterized in that is concerns machines for applying a side glue with two or more strips.

14. A method for applying glue capable of flowing in two essentially parallel running strips on an object, whereby a device is employed, which comprises
two nozzles,
a suspension member where the two nozzles are mechanically fastened and arranged with respect to each other so that their mutual distance is given, an arc-shaped toothed segment, which is connected to the suspension member, and
a pinion, which meshes with the toothed segment.
whereby the following steps are carried out:
(a) rotating the pinion for moving the toothed segment and swivelling the suspension including at least one of the nozzles, whereby due to the swivelling the distance of the parallel running strips on the object is changed:
(b) controlling the two nozzles in order to apply glue in form of the parallel running strips on the object; and
(c) causing a translatory relative motion between the nozzles and the object.

15. The method according to claim 14 characterized in that the controlling of the two nozzles takes place temporally staggered, in order to equalize a spatial offset between the beginning of the two parallel running strips.
